(19) United States
(12) Patent Application Publication
(10) Pub. No.: US 2008/0066632 A1
(43) Pub. Date: Mar. 20, 2008

(54) Device for cutting and/or embossing a pre-cut blank or a material web

(76) Inventor: Reinhard Raueiser, Muden (DE)

Correspondence Address: WILLIAM COLLARD;COLLARD & ROE, P.C., 1077 NORTHERN BOULEVARD, ROSLYN, NY, 11576, US

(21) Appl. No.: 11/901,622

(22) Filed: Sep. 18, 2007

(30) Foreign Application Priority Data
Sep. 19, 2006 (DE) 10 2006 044 610

(51) Int. Cl. B31F 1/07

(52) U.S. Cl. 101/24

(57) ABSTRACT

A device for cutting and/or embossing a sheet, a pre-cut blank, or a material web has a cutting and/or embossing roller having a longitudinal axis, which is mounted, at its two ends, in at least one bearing so as to rotate, a counter-roller that works together with the embossing roller and is mounted so as to rotate, and a force application device for applying a pressure force to a circumference surface of the cutting and/or embossing roller. This device makes it possible to set a uniform gap width of the gap between the cutting and/or embossing roller and the counter-roller, over its axial width. The pressure force applied to the circumference surface is diverted by the force application device into the at least one bearing by way of at least one part of the cutting and/or embossing roller, so that the pressure force is not applied to the counter-roller.

### BACKGROUND OF THE INVENTION

1. Field of the Invention

The present invention relates to a device for cutting and/or embossing a sheet, a pre-cut blank, or a material web. The sheet can be, for example, a paperboard sheet from which folded box blanks are cut. The pre-cut blank can be, for example, pre-cut blanks for envelopes, which are cut and/or embossed within the framework of the production of finished envelopes. The material web can be, for example, a paper web from which pre-cut blanks for envelopes or labels are cut.

2. The Prior Art

A punching device for the production of labels is described in German Patent No. DE 103 05 032 B3, which has rotatably mounted punching and counter-pressure rollers. Each of the two rollers has two so-called bearer rings, in the form of closed circumferential running surfaces, on its circumference. The punching roller and the counter-pressure roller are pressed against one another with relatively great forces at these running surfaces that roll on one another, in order to avoid disruptive roller vibrations during operation of the punching device, and thereby to guarantee as constant a gap width as possible between the two rollers, in the axial direction. For this purpose, a force application device in the form of two pairs of rolls presses down on the running surfaces of the bearer rings of the punching roller.

Bearer rings have the disadvantage that they heat up due to the Hertz pressure and the slip between the running surfaces that roll on one another, and therefore lead to non-uniform deformations of the roller gap. A certain slip always occurs, since the diameters of the bearer rings are never the same, for example in order to have the possibility of regrinding them, but the drive gear wheels force the rollers to run the same. Furthermore, dirt that gets onto the bearer rings can cause variations in the gap width, which will lead to deterioration of the punching result.

With the known devices having bearer rings, the pressure force applied by the force application device acts on the counter-roller in addition to the inherent weight force and the punching force during the punching process. Therefore, the counter-pressure roller is bent relatively greatly in comparison with the punching roller, so that the gap between the two rollers is deformed in a non-uniform manner, which in turn can have the consequence of a deterioration of the quality of the punching result.

Devices of the type in question that do not have bearer rings are also known. If, in the case of these devices, standard bearings always having more or less play are used to mount the punching roller, the punching roller can be lifted during the punching process, within the framework of the bearing play, and this can lead to a change in the gap width between the two rollers, and therefore to a deterioration of the punching result. In order to eliminate this disadvantage, expensive bearings that are free of play must be used to mount the punching roller, in the case of devices that do not have bearer rings.

Another disadvantage of the known devices with or without bearer rings s that because of the relatively great distance between the bearing points, relatively great bending of the rollers occurs.

A device having a cutting roller disposed on top and a counter-pressure roller disposed on the bottom is described in International Publication WO 2006/004474, which describes that each of the rollers has bearer rings, which are used to press the rollers against one another. The bearings of the counter-pressure roller are disposed offset towards one another, so that the distance between them is less than the distance between the bearings of the cutting roller. The bearer rings are situated, in the axial direction, between the bearing of the cutting roller that lies farther on the outside, and the bearing of the cutting roller that lies farther on the inside, in each instance.

In the case of this known device, the bearing points of the counter-pressure roller have a pressure force that is directed upward applied to them, counter to their inherent weight, so that the counter-pressure roller bends upward between the bearer rings. The cutting roller also bends upward, because of the pressure force transferred to it by way of the bearer rings. During the cutting operation, during which the material to be cut is guided between the rollers, a cutting force occurs, which acts downward on the counter-pressure roller, on the one hand, and upward on the cutting roller, on the other hand. As a result, the bending of the counter-pressure roller, which is directed upward, is compensated, so that the latter runs in a straight line horizontally, i.e. essentially without bending. The cutting roller, on the other hand, is additionally bent upward, so that again, a non-uniformly deformed gap occurs. Because the bearer rings are present, the disadvantages connected with them exist here, as well.

### SUMMARY OF THE INVENTION

It is therefore an object of the present invention to create a device for cutting and/or embossing a sheet, a pre-cut blank, or a material web, which makes it possible to set a uniform gap width of the gap between the cutting and/or embossing roller and the counter-roller, over the extent of their axial width.

b) Solution for the Task

This task is accomplished by a device for cutting and/or embossing a sheet, a pre-cut blank, or a material web, comprising a cutting and/or embossing roller having a longitudinal axis, which is mounted, at its two ends, in at least one bearing, so as to rotate, a counter-roller that works together with the embossing roller and is mounted so as to rotate, and a force application device for applying a pressure force to a circumference surface of the cutting and/or embossing roller. The pressure force applied to the circumference surface by the force application device is diverted into each bearing by way of at least one part of the cutting and/or embossing roller, so that the pressure force (F) is not applied to the counter-roller.

It is proposed, according to the invention, to divert the pressure force applied by the force application device to the circumference surface of the cutting and/or embossing roller, through at least one part of the cutting and/or embossing roller, completely into its mounting, so that the pressure force is not applied to the counter-roller. This means that according to the invention, no forces are transferred between the cutting and/or embossing roller and the counter-roller during operation, except by way of the material situated between the rollers. The force transferred between the rollers by way of the material situated between them, during the cutting and/or embossing operation, will be referred to as cutting and/or embossing force hereinafter.

The cutting and/or embossing roller always demonstrates a certain bending, according to the invention. The amount of this bending can be varied by setting the amount of the pressure force applied to it, so that bending of the counter-roller occurs during the cutting and/or embossing operation, at which the bending lines of the cutting and/or embossing roller as well as of the counter-roller have essentially the same curvature at least in their axial segments that are relevant during operation, and could be laid onto one another there, accordingly, essentially with the same coverage. According to the invention, a uniform gap width of the gap between the cutting and/or embossing roller and the counter-roller is achieved in this way, at least over the relevant axial width of the rollers. Since only its own inherent weight force and the cutting and/or embossing force act on the counter-roller, the bending of the counter-roller is advantageously reduced, and the uniformization of the gap width by adaptation of the bending lines of the two rollers to one another can take place on a reduced bending level.

The pressure force applied and the inherent weight force press the cutting and/or embossing roller into a certain direction, in such a manner that any bearing play that might be present in the bearings of the cutting and/or embossing roller is suppressed, in the manner of a bias, i.e. is not available for a movement of the cutting and/or embossing roller. Preferably, standard bearings that are subject to play can therefore be used within the scope of the present invention. The sum of the inherent weight force of the cutting and/or embossing roller and the vertical component of the pressure force that acts on it is always greater, according to the invention, than the cutting and/or embossing force that acts vertically upward.

Because the Hertz pressure is no longer present, and the slip between the cutting and/or embossing roller and the counter-roller is no longer present, the heat development during rotation of the rollers, which occurs in the state of the art, when the bearer rings roll on one another, is furthermore avoided. As a result, heat expansions and any related deformations of the gap between the two rollers are advantageously avoided.

Another advantage of the device according to the present invention is that it can be used not only in connection with solid rollers, but also in connection with rollers that have foil blades releasably affixed to their surfaces. In the case of the previous bearer ring systems, the use of foil blades having alternating thickness was not possible, since a change in foil blade thickness would have required machining of the bearer rings.

A gap adjustment device can be provided to set the gap width between the cutting and/or embossing roller and the counter-roller. This gap adjustment device has the pressure force diverted into the bearing of the cutting and/or embossing roller applied to it, i.e. is biased with this force. The gap adjustment device can be, for example, at least one wedge that acts between the rollers, which can be moved using an adjustment mechanism that can be activated manually.

The force application device is preferably at least one pivot lever mounted so as to pivot about a pivot axis, on which at least one pressure roll is mounted at a distance from the pivot axis. By activating the pivot lever at its end facing away from the pivot axis, the pressure roll is pressed against the circumference surface of the cutting and/or embossing roller, and thereby the pressure force is exerted on the cutting and/or embossing roller.

Preferably, the pressure roll engages at a point on the circumference surface of the cutting and/or embossing roller that is disposed lying horizontally offset to its longitudinal axis. In this way, a stable equilibrium situation of the rollers is achieved even if the longitudinal axes of the two rollers lie precisely on top of one another vertically. It is particularly advantageous to furthermore offset the longitudinal axes of the two rollers horizontally with regard to one another. This creates a further improved stable equilibrium situation of the rollers relative to one at the engagement point of the pressure roll that lies offset relative to the longitudinal axis of the cutting and/or embossing roller.

According to the invention, the cutting and/or embossing roller can be driven by a motor, and can transfer its rotational movement to the counter-roller by a gear wheel drive. For this purpose, the cutting and/or embossing roller has a drive gear wheel that meshes with a driven gear wheel of the counter-roller. The drive gear wheel or the driven gear wheel can be structured, according to the invention, so that it is divided along a radial plane of the cutting and/or embossing roller or the counter-roller, and can comprise a first partial gear wheel as well as a second partial gear wheel. The two partial gear wheels can be connected, relative to one another, so that they can rotate about the longitudinal axis of the cutting and/or embossing roller or the counter-roller, or so that they are fixed in place to rotate with the cutting and/or embossing roller or the counter-roller, in any desired chosen rotation position. As soon as gear play occurs between the drive gear wheel and the gear wheel driven by it, particularly as the result of a change in the gap width by means of the gap adjustment device, the fixation of the partial gear wheels relative to one another can be released, and the gear play can be balanced out by turning the partial gear wheels relative to one another.

Furthermore, in addition to the force application device that applies force to the cutting and/or embossing roller, another force application device can be provided, which applies a counter-force to the counter-roller, which force acts essentially in the opposite radial direction to the direction of the pressure force, and which is completely diverted into the bearings of the counter-roller if there is no material situated between the rollers. In this manner, it possible to actively apply a counter-force to the counter-roller, in such an amount that the resulting bending lines both of the cutting and/or embossing roller and of the counter-roller, during the cutting and/or embossing operation, run essentially in a straight line and are no longer curved. The additional force application device can be configured, in terms of its structure, identical to the force application device that applies force to the cutting and/or embossing roller.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a sectional view of an embodiment of the device according to the invention, in a radial viewing direction; and

FIG. 2 shows a sectional view of the same embodiment of the device according to the invention, in an axial viewing direction.

### DETAILED DESCRIPTION OF THE PREFERRED EMBODIMENT

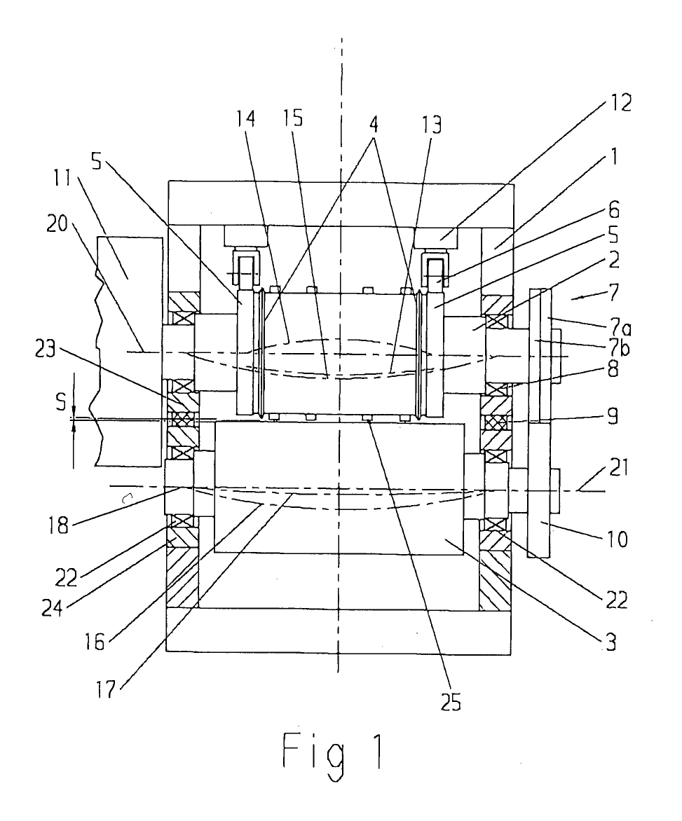

Referring now in detail to the drawings, FIG. 1 shows a sectional view of an embodiment of the device according to the invention in a radial viewing direction. This is a cutting and embossing roller arrangement for the simultaneous cutting and embossing of paperboard. However, a pure cutting roller arrangement or pure embossing roller arrangement is also possible within the scope of the present invention.

As shown in FIG. 1, a cutting and embossing roller 2—referred to simply as a cutting roller 2 hereinafter, for the sake of simplicity—is mounted in a frame 1 using two bearings 8, so as to rotate. Bearings 8 are preferably standard bearings. Cutting roller 2 carries two cutting blades 4 as well as embossing pins 25 on its mantle surface, for cutting and embossing paperboard from which pre-cut blanks for folded boxes are produced. The geometry of cutting blades 4 and embossing pins 25, respectively, is structured in accordance with the application case and the cutting task or embossing task. In the embodiment shown, the paperboard is cut in a straight line and embossed, at the same time.

In FIG. 1, below cutting roller 2, a counter-roller 3 having an essentially smooth mantle surface is mounted in bearings 22, so as to rotate. However, a non-smooth mantle surface of counter-roller 3 is also possible, for example if it is configured as a matrix roller having depressions to accommodate embossing pins, in the case of an embossing roller arrangement. Bearings 22 are preferably also roller bearings. At least longitudinal axis 20 of cutting roller 2 always lies above longitudinal axis 21 of counter-roller 3, within the scope of the present invention. In the present case, the distance between the cutting edges of cutting blades 4 and the mantle surface of counter-roller 3 is referred to as the gap width S, which can be adjusted as a function of the thickness and type of the material to be cut, in a manner that will be described below. The distance between the outer ends of embossing pins 25 and the mantle surface of counter-roller 3 can deviate from gap width S.

The drive of the device according to the invention takes place using a motor 11, which is disposed at the left end of cutting roller 2 in FIG. 1. Motor 11 puts cutting roller 2 into rotation, whereby its rotational movement is transferred to counter-roller 3 using a drive gear wheel 7. As can be seen in FIG. 1, drive gear wheel 7 is connected to cutting roller 2 so as to rotate with it, at its end that lies opposite motor 11. It meshes with a gear wheel 10 of the same size, which is connected with counter-roller 3 so as to rotate with it, so that the rotational movement of cutting roller 2 is transferred to the counter-roller 3 with a translation ratio of 1:1. Only the direction of rotation of counter-roller 3 is opposite to that of cutting roller 2.

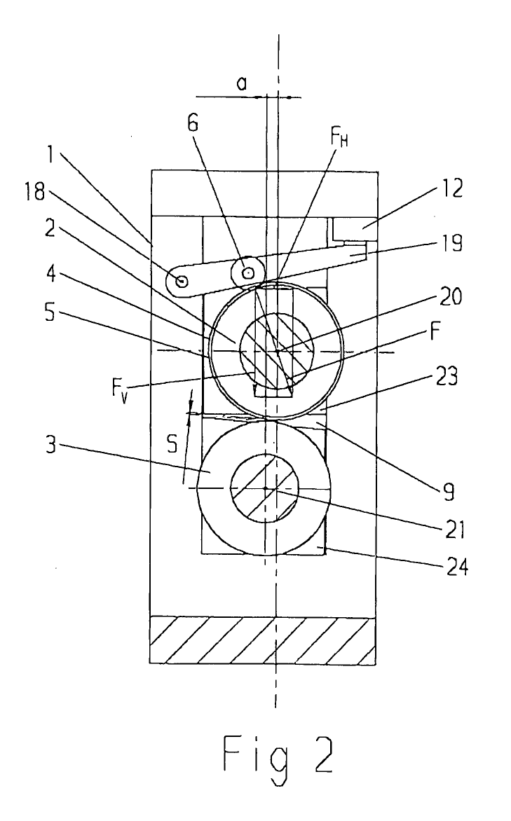

In the embodiment shown, cutting roller 2 has two closed rotating circumference surfaces 5 that serve as running surfaces for two pressure rolls 6 that are mounted so as to rotate. Circumference surfaces 5 can be configured so that they are elevated or recessed as compared with the adjacent mantle surfaces of cutting roller 2, or can end flush with the adjacent mantle surfaces. Pressure rolls 6 form a part of a force application device that is used to apply a pressure force F (see FIG. 2) to cutting roller 2, which force acts in the radial direction.

As shown in FIG. 2, each of the two pressure rolls 6 is mounted, so as to rotate, on a pivot lever 19, which in turn is mounted on frame 1, so as to rotate about its pivot axis 18. In FIG. 2, a force transfer organ 12 that is activated hydraulically, for example, engages on the end of pivot lever 19 that lies opposite pivot axis 18, and presses it downward, so that pressure rolls 6 exert the pressure force F shown in FIG. 2 on cutting roller 2. In this connection, the point at which pressure roll 6 engages on circumference surface 5 is offset to the left as compared with longitudinal axis 20 of cutting roller 2 in FIG. 2. Even in the case that longitudinal axis 20 of cutting roller 2 were to lie precisely vertically above longitudinal axis 21 of counter-roller 3, the horizontal component FH of the pressure force F brings about a relatively stable equilibrium situation of the cutting roller 2 relative to counter-roller 3.

However, as shown in FIG. 2, in the case of the embodiment shown, longitudinal axis 20 of cutting roller 2 is offset to the right, by horizontal offset a, relative to longitudinal axis 21 of counter-roller 3. Thus, in the case of the embodiment shown, it is reliably avoided, due to the horizontal force component FH and the horizontal offset a, that cutting roller 2 and counter-roller 3 perform undesirable vibrations relative to one another, because of an unstable equilibrium situation. The pressure force F exerted on cutting roller 2 by the two pressure rolls 6 is completely diverted into bearings 8 held in frame 1, according to the invention, by means of that partial segment of cutting roller 2, in each instance, that lies between circumference surface 5 and bearing 8. In this connection, cutting roller 2 is pressed in the direction of effect of pressure force F, which can be seen in FIG. 2, by the path distance of the existing bearing play.

In FIG. 1, three bending lines 13, 14, and 15 of cutting roller 2 are shown. In this connection, the progression of longitudinal axis 20 characterizes the zero level of bending. Bending line 14 results from the cutting and embossing force that acts essentially vertically upward on cutting roller 2 during the cutting and embossing process, as a function of the amount of the horizontal offset al. Bending line 15 results from the sum of the inherent weight force of cutting roller 2 and vertical component FV of the pressure force F. Bending line 13 is the total bending line that results from addition of bending lines 14 and 15.

Bending lines 16 and 17 of counter-roller 3 are furthermore shown in FIG. 1. Here, longitudinal axis 21 represents the zero level of bending. Bending line 17 results from the inherent weight force of counter-roller 3. Bending line 16 represents the bending that results from the sum of inherent weight force and cutting and embossing force.

In the axial segment of cutting roller 2 that is situated between the two circumference surfaces 5, bending line 13 of cutting roller 2 essentially corresponds to bending line 16 of counter-roller 3, if pressure force F is suitably selected. As a result, cutting roller 2 and counter-roller 3 are bent in the same manner, at least in this axial segment, and have an essentially equal gap width, in the axial direction, in this axial segment.

Pressure force F applied to cutting roller 2 by pressure rolls 6 in no way acts directly on counter-roller 3, so that bending line 16 shown in FIG. 1 hangs down significantly less, qualitatively, than the bending lines of the counter-rollers of the devices known from the state of the art, which produce contact between the cutting roller and the counter-roller by means of bearer rings. Because of the relatively slight bending of counter-roller 3, a uniformly wide gap is achieved over the entire relevant axial segment of rollers 2, 3, while simultaneously achieving a relatively slight absolute value of the bending, in advantageous manner.

Since no kind of contact at all exists between cutting roller 2 and counter-roller 3, according to the invention, beyond the material to be cut, no additional force that is directed upward acts on cutting roller 2, aside from the cutting and embossing force. In the embodiment shown, bending line 13 still hangs down in FIG. 1. In this manner, the result is brought about that the cutting and embossing force that occurs does not lift cutting roller 2 out of its bias brought about by pressure force F, which would make it possible for the cutting edges of cutting blades 4 as well as embossing pins 25 to move in the radial direction, within the scope of the play of bearings 8 that might be present. Thus, the preferable mounting of cutting roller 2 in standard bearings that are subject to play is possible without the risk of poor cutting and embossing results.

Setting of the gap width S of the gap takes place using a gap adjustment device that acts between bearings 8 and 22 of cutting roller 2 and counter-roller 3, respectively, which device is configured, in the embodiment shown, in the form of two adjustable wedges 9. Wedges 9 can be moved to the left or right in FIG. 2, for example using a hand wheel, not shown, and are situated between two bearing pads 23 and 24, in each instance, which are mounted in frame 1 without play in the vertical direction, so that they can be moved. Bearing pad 23 accommodates bearing 8, in each instance, while bearing pad 24 accommodates bearing 22, in each instance. As can best be seen in FIG. 1, pressure force F diverted into bearings 8 is transferred to wedges 9 by way of bearing pads 23, so that wedges 9 lift cutting roller 2 indirectly, by way of bearing pads 23, as well as lifting bearings 8 counter to the diverted pressure force F, in the case of a movement to the left in FIG. 2. Bearing pads 24 assigned to counter-roller 3 do not move when gap width S is adjusted.

During adjustment of gap width S, the distance between longitudinal axes 20 and 21 relative to one another changes, of course, so that the engagement conditions between drive gear wheel 7 and driven gear wheel 10 change, as well. In particular, gear play can occur, since the individual gear flanks no longer rest against one another in the same manner as before the change in gap width S. Such gear play can influence the quality of the cutting and embossing result in undesirable manner, after the gap width S is changed.

To balance out this disadvantageous gear play, it is preferably provided, according to the invention, to configure drive gear wheel 7 as a gear wheel that is divided in a plane essentially perpendicular to longitudinal axis 20 of cutting roller 2, and accordingly has a first partial gear wheel 7a as well as a second partial gear wheel 7b. The two partial gear wheels 7a, 7b can be turned relative to one another, so that at least one of the two partial gear wheels 7a, b can be brought into such a rotational position, and fixed in place there, in which its teeth mesh with driven gear wheel 10 of counter-roller 3 without gear play. Partial gear wheels 7a, 7b can both be fixed in place on cutting roller 2 so as to rotate with it.

Alternatively, it is possible to fix only one of the two partial gear wheels 7a, 7b in place on cutting roller 2, and to configure the partial gear wheel that cannot be fixed in place on cutting roller 2 so that it can be fixed in place on the other partial gear wheel. In this way, the divided drive gear wheel 7 makes it possible to balance out any gear play that might be present, in simple manner. Alternatively, driven gear wheel 10 can be divided, instead of drive gear wheel 7, in analogous manner.

As is evident from the above description, the following advantageous effect is particularly achieved with the present invention.

The gap between the cutting and/or embossing roller and the counter-roller can be configured with a uniformly great gap width, at least in the axial segment of the rollers that is relevant for the cutting and/or embossing process.

Accordingly, while only a few embodiments of the present invention have been shown and described, it is obvious that many changes and modifications may be made thereunto without departing from the spirit and scope of the invention.

### REFERENCE SYMBOL LIST

1 frame
2 cutting roller
3 counter-roller
4 cutting blade
5 circumference surface
6 pressure roll
7 drive gear wheel
7a, 7b partial gear wheels
8 bearing
9 wedge
10 gear wheel
11 motor
12 force transfer organ
13 bending line of the cutting roller (sum of bending lines 14, 15)
14 bending line of the cutting roller (cutting force)
15 bending line of the cutting roller (inherent weight+vertical component FV)
16 bending line of the counter-roller (inherent weight+cutting force)
17 bending line of the counter-roller (inherent weight)
18 pivot axis
19 pivot lever
20 longitudinal axis of the cutting roller
21 longitudinal axis of the counter-roller
22 bearing
23 bearing pad
24 bearing pad
25 embossing pin
a horizontal offset
F pressure force
S gap width
FH horizontal component of the pressure force F
FV vertical component of the pressure force F

What is claimed is:

1. A device for cutting or embossing a sheet, a pre-cut blank, or a material web, comprising:
a cutting or embossing roller having a longitudinal axis, said roller having two ends and each end being mounted in at least one bearing so as to rotate;
a counter-roller that works together with the embossing roller and is mounted so as to rotate; and
a force application device for applying a pressure force (F) to a circumference surface of the cutting or embossing roller;
wherein the pressure force (F) applied to the circumference surface by the force application device is diverted into each of the bearings by at least one part of the cutting or embossing roller, so that the pressure force (F) is not applied to the counter-roller.

2. A device according to claim 1, further comprising a gap adjustment device for setting a gap width (S) of a gap between the cutting or embossing roller and the counter-roller, wherein the diverted pressure force is applied to the gap setting device.

3. A device according to claim 2, wherein the gap adjustment device comprises at least one adjustable wedge.

4. A device according to claim 1, wherein the force application device comprises at least one pivot lever mounted so as to pivot about a pivot axis, and further comprising at least one pressure roll that works together with the circumference surface, said pressure roll being mounted on the pivot lever at a distance from the pivot axis.

5. A device according to claim 4, wherein the pressure roll engages at a point on the circumference surface that is disposed horizontally offset to the longitudinal axis of the cutting or embossing roller.

6. A device according to claim 1, wherein the counter-roller has a longitudinal axis that runs offset relative to the longitudinal axis of the cutting or embossing roller, by a horizontal offset.

7. A device according to claim 1, further comprising a drive gear wheel disposed on the cutting or embossing roller, said drive gear wheel engaging into a driven gear wheel of the counter-roller that the drive gear wheel drives, wherein the drive gear wheel or the driven gear wheel is a divided gear wheel comprising a first partial gear wheel as well as a second partial gear wheel, and the two partial gear wheels can be turned relative to one another to balance out gear play between the drive gear wheel and the driven gear wheel.

8. A device according to claim 1 further comprising an additional force application device that applies a counter-force to the counter-roller, which counter-force acts in a direction essentially opposite to the pressure force.
